(19) United States
(12) Patent Application Publication
(10) Pub. No.: US 2025/0187079 A1
(43) Pub. Date: Jun. 12, 2025

(54) FASTENING COMPONENT

(71) Applicant: TUNGALOY CORPORATION, Fukushima (JP)

(72) Inventor: Takahiro ASO, Fukushima (JP)

(73) Assignee: TUNGALOY CORPORATION, Fukushima (JP)

(21) Appl. No.: 18/890,182

(22) Filed: Sep. 19, 2024

(30) Foreign Application Priority Data
Dec. 7, 2023 (JP) 2023-207113

(51) Int. Cl. B23B 27/10

(52) U.S. Cl. CPC B23B 27/10

(57) ABSTRACT

A fastening component that is fastened to an arbor so as to fix a cutter, being a rotary cutting tool, to the arbor, the fastening component including: a shaft part screwed into an internal thread of the arbor; an engagement hole formed in a shaft center of an end surface that is opposite to an end surface that is fastened to the arbor; a first flow path formed in a shaft center of the shaft part and opened in an end surface of the shaft part which is fastened to the arbor; a third flow path opened, in a position that is away from the shaft center, in an end that is opposite to an end that is fastened to the arbor; and a second flow path connecting the first flow path and the third flow path.

### BACKGROUND

### Field

The present invention relates to a fastening component.

### Description of Related Art

It is known that a fastening component to fix a rotary cutting tool, such as a face milling cutter, a shell end mill, a boring cutter or a side cutter, to an arbor is provided with flow paths, and that coolant is supplied through the flow paths to cutting locations whereby cutting by the rotary cutting tool is effected (see JP2004-237401 A, JP2004-276136 A, JPH02-004714 U and JP2003-522038 A).

For example, JP2004-237401 A discloses a bolt that is provided with a groove which is opened in an end surface in an outer periphery of a shaft part and in which the groove is provided in an extended manner in a direction of the shaft. JP2004-276136 A discloses a structure in which multiple flow paths branch out from a single flow path. JPH02-004714 U discloses that a lid is attached to a head of a fastening component so as to cover a groove formed in the head, leading to the formation of an ejection passage that communicates with multiple flow paths branched out from a single flow path.

Meanwhile, JP2004-276136 A includes five flow paths branched out from a single flow path; however, these flow paths are not enough to evenly spray fluid (coolant) to cutting locations. In addition, a head will be thick because such branched-out flow paths are formed. Further, the fastening component disclosed in JPH02-004714 U requires a lid as a separate member for forming an ejection passage, resulting in complication of the structure and an increase in the number of components.

### SUMMARY

The present invention has been made under the above-described circumstances, and an object of the present invention is to provide a fastening component that prevents complication of the structure and an increase in the number of components, and which is capable of appropriately spraying fluid to cutting locations.

A fastening component according to an aspect of the present invention is a fastening component that is fastened to an arbor so as to fix a rotary cutting tool to the arbor, the fastening component being configured to include: a shaft part screwed into an internal thread of the arbor; an engagement hole formed in a shaft center of an end surface that is opposite to an end surface that is fastened to the arbor; a first flow path formed in a shaft center of the shaft part and opened in an end surface of the shaft part which is fastened to the arbor; a third flow path opened, in a position that is away from the shaft center, in an end that is opposite to an end that is fastened to the arbor; and a second flow path connecting the first flow path and the third flow path.

The fastening component having the above-described structure has a structure in which: fluid that has been supplied to the first flow path is guided, via the second flow path, to the third flow path; and the fluid is discharged from the third flow path toward a cutting location. As a result, the fluid can be appropriately sprayed toward the cutting location, and in addition, complication of the structure and an increase in the number of components can be prevented compared with a fastening component provided with a separate member, such as a lid, or a fastening component that has undergone complicated machining. Further, since the first flow path is formed in the shaft center of the shaft part, a reduction in strength due to the formation of the flow paths can be prevented.

The second flow path may be formed in a position that is nearest to the engagement hole.

The first flow path may have a cross-sectional area that is greater than that of the second flow path, and the second flow path may have a cross-sectional area that is greater than that of the third flow path.

A number of the third flow paths may be greater than a number of the second flow paths, and the number of the second flow paths may be greater than a number of the first flow paths.

A total number of the second flow paths and the third flow paths may be an even number.

The third flow path may be divided into at least a third main flow path and a third sub flow path, and, in a top view, the third main flow path may be arranged so as to form a straight line with the second flow path, and the third sub flow path may be arranged obliquely with respect to the second flow path.

The third sub flow paths that are adjacent to each other may be arranged such that respective extensions thereof intersect with each other.

At least part of the second flow path may have a curved shape.

The third flow path may be opened in a side surface of the end that is opposite to the end that is fastened to the arbor.

### BRIEF DESCRIPTION OF DRAWINGS

FIG. 1 is a perspective view of a cutting tool for which a fastening component according to an embodiment of the present invention is used.

FIG. 2 is an exploded perspective view of the cutting tool for which the fastening component according to the present embodiment is used.

FIG. 3 is a perspective view of the fastening component according to the present embodiment.

FIG. 4 is a perspective view illustrating flow paths formed in the fastening component.

FIG. 5 is a plan view illustrating the flow paths formed in the fastening component.

FIG. 6 is a side view illustrating the flow paths formed in the fastening component.

FIG. 7 is a cross-sectional view of a cutter and the fastening component that illustrate a state of discharge of fluid from the fastening component to cutting locations.

FIG. 8 is a partially enlarged view of FIG. 5.

### DETAILED DESCRIPTION

Embodiments of the present invention will be described in detail below, with reference to the attached drawings.

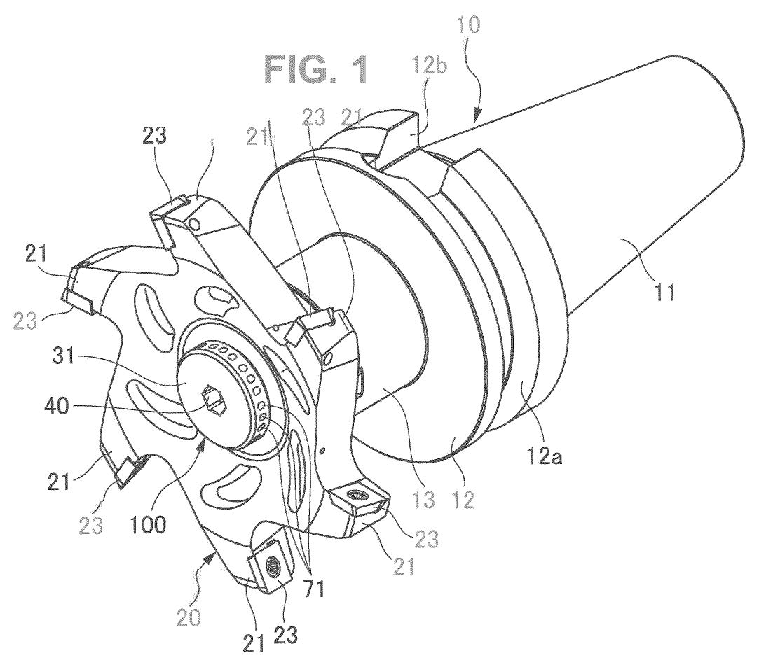

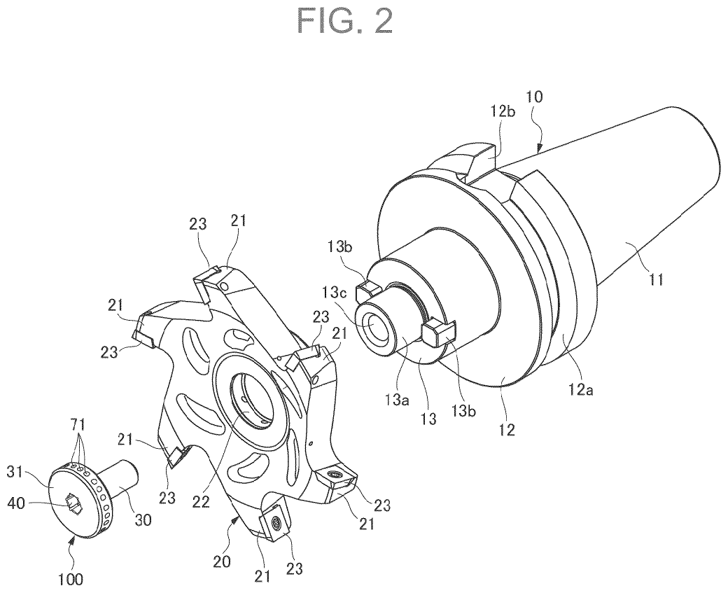

As shown in FIGS. 1 and 2, a fastening component 100 according to an embodiment of the present invention is a bolt for fixation that is fastened to an arbor 10 so as to fix a cutter (rotary cutting tool) 20 to the arbor 10. This example illustrates a case in which the cutter 20 is fixed to the arbor 10; however, the rotary cutting tool is not limited to a face milling cutter, and examples of the rotary cutting tool may also include a shell end mill, a boring cutter and a side cutter.

The arbor 10 is attached to a machine tool, such as a machining center, and mainly has a shank part 11, a flange part 12 and a boss part 13.

The shank part 11 has a tapered shape and is inserted into a taper hole (not shown) of a main shaft of a machine tool. With such configuration, the arbor 10 is fixed to the main shaft of the machine tool.

The flange part 12 is provided with respect to a part of the shank part 11 which is opposite to a part thereof that is attached to the main shaft of the machine tool. The flange part 12 has a V groove 12a and a key groove 12b. The V groove 12a is a groove part that is grasped when a tool is received in a magazine of an automatic tool changer of the machine tool or when a tool change is performed with a tool change arm, and the V groove 12a is formed in a circumferential direction of the flange part 12. The key groove 12b is a groove part into which a key (not shown) of the machine tool is locked, and when the key is locked into the key groove 12b, the arbor 10 is fixed circumferentially with respect to the main shaft of the machine tool.

The boss part 13 is provided opposite to the shank part 11 with respect to the flange part 12. The boss part 13 has, at a leading end thereof, a mounting shaft 13a and keys 13b. The mounting shaft 13a is formed into a cylindrical shape in which an inner circumferential surface thereof has an internal thread 13c. The keys 13b are formed in two locations of a peripheral surface of the mounting shaft 13a.

The cutter 20 is a rotary cutting tool that is mainly used to perform surface machining on a work, and the cutter 20 is mounted on the boss part 13 of the arbor 10. The cutter 20 has a plurality (six in this example) of insert seats 21 and a mounting hole 22. The insert seats 21 are provided in a protruding manner toward an outer periphery of the cutter 20, and cutting tips 23 are mounted respectively on the insert seats 21. The mounting hole 22 is formed in a center of the cutter 20, and the mounting shaft 13a, which is provided in the boss part 13 of the arbor 10, is inserted into the mounting hole 22. Further, the cutter 20 has, in a part thereof that is mounted on the boss part 13 of the arbor 10, two key holes (not shown) into which the keys 13b, which are provided in the boss part 13, are engaged.

With the cutter 20 being mounted on the boss part 13 of the arbor 10, the fastening component 100 is fastened to the arbor 10 by being screwed into the internal thread of the mounting shaft 13a of the boss part 13 of the arbor 10. As a result, the cutter 20 is fixed to the boss part 13 of the arbor 10. Further, the fastening component 100 is a bolt for fixation that comprises flow paths through which fluid (coolant) to be supplied through the arbor 10 is discharged to locations of the cutter 20 whereby cutting by the cutting tips 23 is effected. The fluid to be supplied to the cutting locations is not limited to the coolant, and various types of lubricants and cooling agents may be used, or mist or air may alternatively be supplied.

Next, description will be made below regarding the fastening component 100.

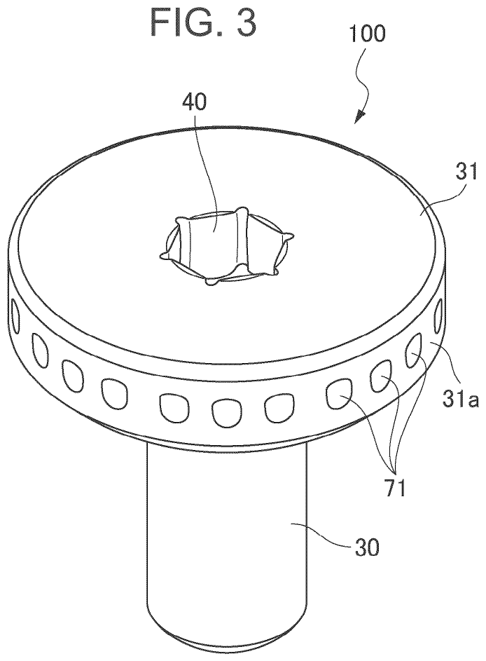

As shown in FIG. 3, the fastening component 100 has a shaft part 30 and an engagement hole 40. One end of the shaft part 30 has a head 31. The head 31 is formed into a circular plate shape with a diameter that is greater than that of the shaft part 30.

The fastening component 100 is molded by, for example, a metal powder sintering 3D printer that three-dimensionally forms a mold using a metal powder. Examples of a molding method with a metal powder sintering 3D printer may include powder bed fusion, electron beam melting (EBM) by which an electron beam is used to melt a powder, and selective laser melting (SLM) by which laser light is used to melt a powder.

The shaft part 30 is a part to be screwed into the mounting shaft 13a of the boss part 13 of the arbor 10, and an external thread is formed in an outer periphery of the shaft part 30.

The engagement hole 40 is formed in a shaft center of an end surface of the fastening component 100 which is opposite to an end surface thereof that is fastened to the arbor 10. The engagement hole 40 is a hole into which a tool, such as a hexagon wrench, can be inserted, and a tool is inserted into the engagement hole 40 when the fastening component 100 is fastened to and unfastened from the arbor 10. Further, the fastening and unfastening of the fastening component 100 are performed by rotating the tool. The engagement hole 40 is not limited to a hexagonal hole, and is a hole, such as a Torx hole, whose shape can be changed such that various tools can be inserted thereinto.

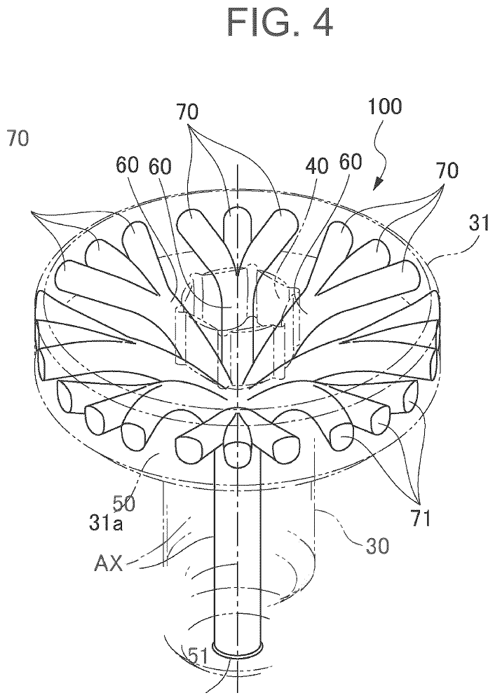

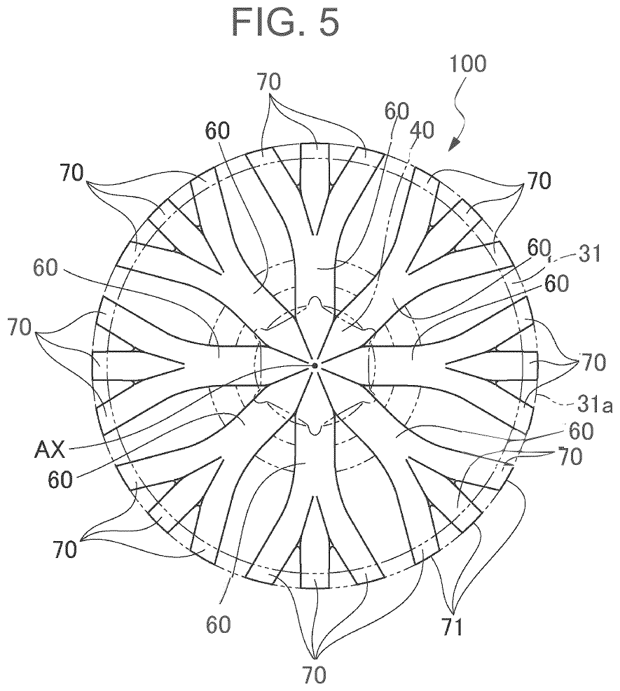

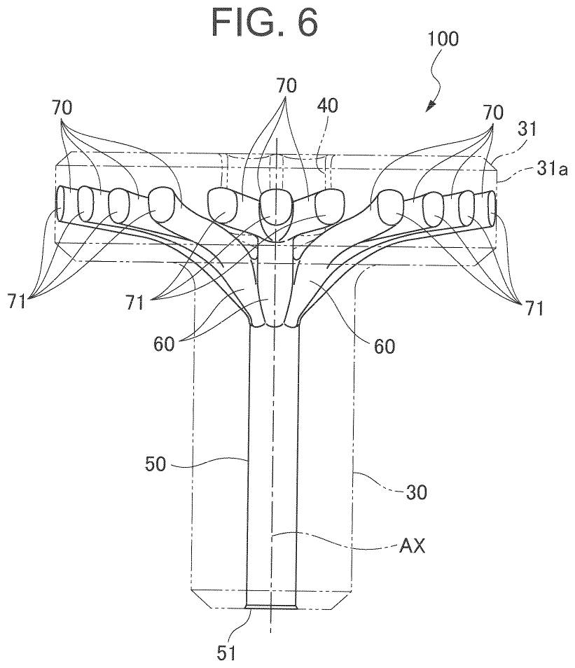

As shown in FIGS. 4 to 6, the fastening member 100 has a first flow path 50, second flow paths 60 and third flow paths 70.

The first flow path 50 is formed in a shaft center AX of the shaft part 30. The first flow path 50 is opened in an end surface of the shaft part 30 which is fastened to the arbor 10, with the opening portion thereof serving as an inlet port 51.

The second flow paths 60 are formed so as to be greater in number (eight in this example) than the first flow path 50. The second flow paths 60 are each formed in a position that is nearest to the engagement hole 40. Namely, the second flow paths 60 are each formed in a position where the second flow path 60 passes through an area that is closer to the engagement hole 40 than the first flow path 50 and the third flow paths 70. The second flow paths 60 are each formed between a position that is near an end of the shaft part 30 which is close to the head 31 and a position that is close to an inner periphery of the head 31, and an end of the second flow path 60 which is close to the shaft part 30 communicates with the first flow path 50. These second flow paths 60 are each formed into a curved shape, and an intermediation portion of the second flow path 60 passes through an area that is near the engagement hole 40. The second flow paths 60 are radially formed around the shaft center AX of the shaft part 30.

The third flow paths 70 are formed so as to be greater in number (twenty-four in this example) than the second flow paths 60. The third flow paths 70 are formed in the head 31. One of the ends of each of the third flow paths 70 communicates with the second flow path 60. In this example, three third flow paths 70 communicate with a single second flow path 60. Further, the other end of the third flow path 70 is opened in an outer peripheral surface 31a of the head 31, and the outer peripheral surface 31a is a side surface of an end of the fastening component 100 which is opposite to an end thereof that is fastened to the arbor 10. Further, the opening portions of the outer peripheral surface 31a of the head 31 serve as discharge ports 71. In this example, the third flow paths 70 are opened in the outer peripheral surface 31a of the head 31; however, it is sufficient for the third flow paths 70 to be opened in a direction away from a shaft center of the fastening component 100; for example, the third flow paths 70 may be opened in an end surface of the fastening component 100 (upper surface of the head 31) or in an edge portion (corner of the head 31) where the end surface of the fastening component 100 and the side surface thereof intersect with each other.

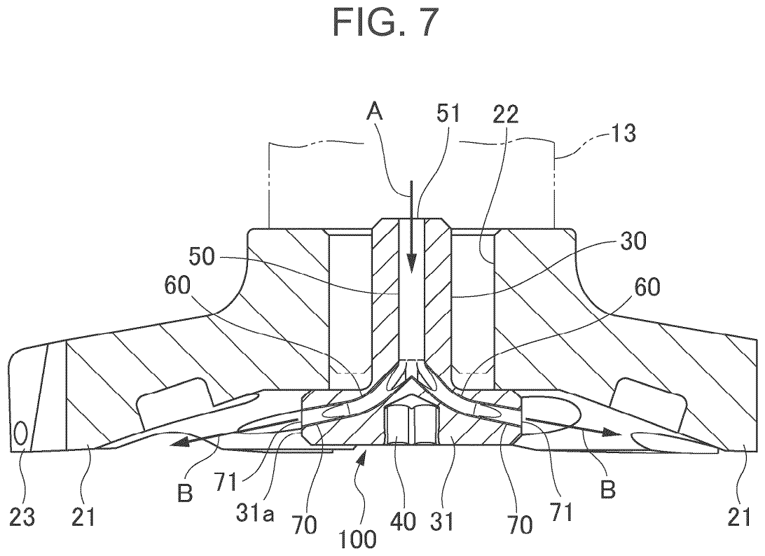

As can be seen from the above, in the fastening component 100, the first flow path 50 and the third flow paths 70 are connected via the second flow paths 60. With such configuration, as shown in FIG. 7, fluid that has flown into the first flow path 50 through the inlet port 51 thereof (see arrow A in FIG. 7) via the arbor 10 flows through the first flow path 50, and the fluid is then split into partial flows so as to flow through the second flow paths 60. The partial flows then flow through the second flow paths 60, and are then each split into partial flows so as to flow through the third flow paths 70. The fluid flows through the third flow paths 70 and is discharged through the discharge ports 71 and toward the outside in a radial direction of the head 31, and is then discharged toward cutting locations of the cutter 20 whereby cutting by the cutting tips 23 is effected (see arrows B in FIG. 7).

Here, the first flow path 50 has a cross-sectional area that is greater than the second flow path 60, and the second flow path 60 has a cross-sectional area that is greater than the third flow path 70. Namely, the first flow path 50, the second flow path 60 and the third flow path 70 are in descending order in terms of cross-sectional area. Thus, when fluid flows through the first flow path 50, the second flow paths 60 and the third flow paths 70 in this order, the fluid can be prevented from suffering pressure loss, so that the fluid can be appropriately sprayed toward the cutting locations.

The total number of the second flow paths 60 and the third flow paths 70 is an even number. This example provides the eight second flow paths 60 and the twenty-four third flow paths 70, and the total number is thirty-two. Further, in the fastening component 100, the second flow paths 60 and the third flow paths 70 are arranged at point symmetric positions, whereby the weight balance of the fastening component 100 and the dynamic balance thereof can be kept.

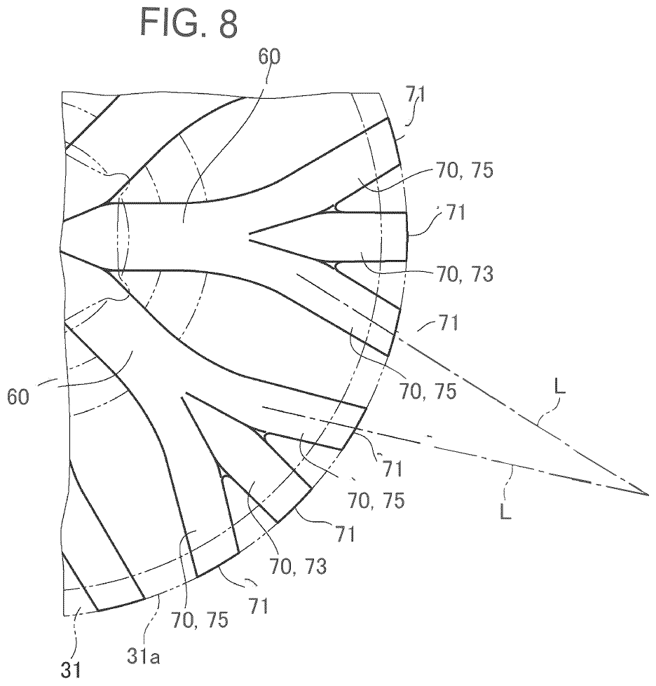

As shown in FIG. 8, the three third flow paths 70 that communicate with each of the second flow paths 60 are: one third main flow path 73; and two third sub flow paths 75. Further, in a top view of the fastening component 100, the third main flow path 73 is arranged so as to form a straight line with the second flow path 60, and the third sub flow paths 75 are arranged obliquely with respect to the second flow path 60. With such configuration, the third sub flow paths 75 each extend from a location thereof that communicates with the second flow path 60 toward the outer peripheral surface 31a of the head 31 in a direction gradually away from the third main flow path 73.

As a result, the fluid that is guided from the second flow path 60 to the third main flow path 73 is discharged onto an extension of the second flow path 60, and the fluid that is guided from the second flow path 60 to the third sub flow paths 75 is discharged obliquely with respect to the second flow path 60. Accordingly, the fluid can be evenly sprayed toward the cutting locations.

In the head 31, the third sub flow paths 75 that are adjacent to each other are arranged such that respective extensions L thereof intersect with each other. Thus, the flows of fluid respectively discharged from the adjacent third sub flow paths 75 come into collision with each other so as to compensate for the flow rate, whereby a sufficient amount of fluid can be sprayed toward the cutting locations.

As described above, the fastening component 100 according to the present embodiment has the following structure in which: fluid that has been supplied to the first flow path 50 is guided, via the second flow paths 60, to the third flow paths 70; and the fluid is discharged from the third flow paths 70 toward the cutting locations. As a result, the fluid can be appropriately sprayed toward the cutting locations, and in addition, complication of the structure and an increase in the number of components can be prevented compared with a fastening component provided with a separate member, such as a lid, or a fastening component that has undergone complicated machining. Further, since the first flow path 50 is formed in the shaft center AX of the shaft part 30, a reduction in strength due to the formation of the flow paths can be prevented.

Moreover, since the second flow paths 60 are each formed in a position that is nearest to the engagement hole 40, miniaturization of the fastening component can be achieved, putting the engagement hole 40 aside. Meanwhile, the second flow paths 60 allow the first flow path 50 and the third flow paths 70 to be connected.

In addition, since the second flow paths 60 each have a curved shape, the fluid flowing through the second flow path can be prevented from suffering flow-rate loss. Meanwhile, the second flow path 60 can be located close to the engagement hole 40, so that a reduction in size of the fastening component 100 can be achieved.

Furthermore, since the third flow paths 70 are greater in number than the second flow paths 60, and also since the second flow paths 60 are greater in number than the first flow path 50, the fluid that is discharged from the third flow paths 70 can be evenly sprayed toward the cutting locations. Further, the third flow paths 70, which are greater in number than the second flow paths 62, are formed, whereby the number of the second flow paths 60 can be kept low, so that a reduction in the strength of the area around the engagement hole 40 can be prevented while the fluid can be appropriately sprayed toward the cutting locations.

The present invention provides a fastening component that prevents complication of the structure and an increase in the number of components, and which is capable of appropriately spraying fluid to cutting locations.

What is claimed is:

1. A fastening component that is fastened to an arbor so as to fix a rotary cutting tool to the arbor, the fastening component comprising:
a shaft part screwed into an internal thread of the arbor;
an engagement hole formed in a shaft center of an end surface that is opposite to an end surface that is fastened to the arbor;
a first flow path formed in a shaft center of the shaft part and opened in an end surface of the shaft part which is fastened to the arbor;
a third flow path opened, in a position that is away from the shaft center, in an end that is opposite to an end that is fastened to the arbor; and
a second flow path connecting the first flow path and the third flow path.

2. The fastening component according to claim 1, wherein the second flow path is formed in a position that is nearest to the engagement hole.

3. The fastening component according to claim 1, wherein the first flow path has a cross-sectional area that is greater than that of the second flow path, and the second flow path has a cross-sectional area that is greater than that of the third flow path.

4. The fastening component according to claim 1, wherein a number of the third flow paths is greater than a number of the second flow paths, and the number of the second flow paths is greater than a number of the first flow paths.

5. The fastening component according to claim 1, wherein a total number of the second flow paths and the third flow paths is an even number.

6. The fastening component according to claim 1, wherein:
the third flow path is divided into at least a third main flow path and a third sub flow path; and
in a top view, the third main flow path is arranged so as to form a straight line with the second flow path, and the third sub flow path is arranged obliquely with respect to the second flow path.

7. The fastening component according to claim 6, wherein the third sub flow paths that are adjacent to each other are arranged such that respective extensions thereof intersect with each other.

8. The fastening component according to claim 1, wherein at least part of the second flow path has a curved shape.

9. The fastening component according to claim 1, wherein the third flow path is opened in a side surface of the end that is opposite to the end that is fastened to the arbor.
